(19) United States
(12) Patent Application Publication
(10) Pub. No.: US 2009/0267996 A1
(43) Pub. Date: Oct. 29, 2009

(54) HEATER STACK WITH ENHANCED PROTECTIVE STRATA STRUCTURE AND METHODS FOR MAKING ENHANCED HEATER STACK

(76) Inventors: Byron Vencent Bell, Paris, KY (US); Yimin Guan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/109,872

(22) Filed: Apr. 25, 2008

(51) Int. Cl. B41J 2/05

(52) U.S. Cl. 347/62

(57) ABSTRACT

A heater stack includes first strata configured to support and form a heater element responsive to electrical activation and second strata overlying the first strata and having different thicknesses in various portions overlying the heater element to enhance its protection from adverse effects of cavitation occurrences on the second strata. A first portion of the second strata where adverse effects of cavitation occurrences are more likely overlies opposite ends of the heater element and has a first thickness. A second portion of the second strata where adverse effects of cavitation occurrences are less likely has a planar structure overlying and extending between the opposite ends of the heater element. The second portion also has a second thickness less than the first thickness of the first portion. The first portion has a step-like structure relative to and protruding above the planar structure of the second portion.

### BACKGROUND

1. Field of the Invention

The present invention relates generally to micro-fluid ejection devices and, more particularly, to a heater stack of a micro-fluid ejection device with an enhanced protective strata structure and a method for making the enhanced heater stack.

2. Description of the Related Art

Conventionally, a micro-fluid ejection device such as a thermal inkjet printhead includes an access to a local or remote supply of color or mono ink, a heater chip, a nozzle plate attached to or integrated with the heater chip, and an input/output connector, such as a tape automated bond (TAB) circuit, for electrically connecting the heater chip to a printer during use. The heater chip, in turn, is made up of a plurality of resistive heater elements, each being part of a heater stack. The term “heater stack” generally refers to the structure associated with the thickness of the heater chip that includes first, or heater forming, strata made up of resistive and conductive materials in the form of layers or films and second, or protective, strata made up of passivation and cavitation materials in the form of layers or films, all fabricated by well-known processes of deposition, patterning and etching upon a substrate of silicon. Also, one or more fluid vias or slots that are cut or etched through the thickness of the silicon substrate and the first and second strata, using these well-known processes, serve to fluidly connect the supply of ink to the heater stacks.

To print or emit a single drop of ink, a heater formed in the first strata of each heater stack is uniquely addressed by a voltage pulse provided by a printer energy supply circuit. Each voltage pulse applied to the heater element causes superheating to occur, which momentarily vaporizes the portion of the ink in contact with the heater stack to nucleate and form a vapor bubble in an ejection chamber located between the heater stack and an opening in the nozzle plate spaced above the heater stack. As the vapor bubble grows or expands, its momentum is transferred to the surrounding fluid, forcing ink in the ejection chamber toward the adjacent nozzle plate. Then, upon collapse of the vapor bubble, following its expansion, the surrounding fluid reverses direction and retracts away from the adjacent nozzle plate resulting in its separation from a small quantity of fluid concurrently moving or jetting through the opening of the nozzle plate which then ejects in the form of a single drop that is projected by the nozzle plate onto a print medium.

Heretofore, in the second strata of the heater stack the passivation layer overlying the layers of the first strata forming the heater has taken the form of a relatively thick monolayer of a suitable material, such as silicon nitride (SiN), or a bilayer of a combination of suitable materials, such as silicon nitride/silicon carbide (SiN/SiC). The cavitation layer of the second strata overlying the passivation layer has taken the form of a monolayer of a suitable material, such as tantalum (Ta) or the like. The cavitation and passivation layers of the second strata protect a resistive heater element of the heater from damage due respectively to the fluid forces and motions of the ink, such as occur in the ejection chamber during bubble expansion and collapse, and to the corrosive chemical effects of the ink itself.

It will be readily understood, therefore, that it is in the ejection chamber between the heater stack and nozzle opening that a repetitive cycle of bubble expansion and collapse occurs, causing the jetting of ink drops from the nozzle opening, in response to electrical pulses applied to the resistive heater element of the heater in the heater stack, which results in printing by the impact of jetted ink drops on the medium, such as a sheet of paper, positioned adjacent to the nozzle plate. Thus, it can be easily realized that heater reliability is extremely crucial for printhead printing performance. This repetitive cycle of bubble expansion and collapse, however, has adverse effects on heater reliability. During ink jetting, the resistive heater element surface experiences various stresses, such as chemical attack due to inks, thermal stress, electrical stress, and mechanical stress due to cavitation and to thermal coefficient of expansion (TCE) mismatch.

Mechanical stress due to cavitation, caused primarily by fluid forces created during bubble expansion and collapse, results in damage on the surface of the above-described second strata in the form of an erosion thereof and primarily at its intermediate wall portions where it transitions from an outer portion to a central portion of the second strata of the heater stack overlying the resistive heater element thereof. This cavitation damage is the primary cause of heater stack failure.

To protect the resistive heater element surface from cavitation damage, one approach is to cover the surface area extending from the outer portion to the central portion of the second strata layers with a passivation overcoat (PO) layer of SiO₂. However, this approach has not been satisfactory because the overcoat layer tends to delaminate from the underlying cavitation layer due to TCE mismatch. As a result of this delamination, ink will attack the exposed interface of these layers due to local nucleation and cause premature heater stack failure. (The term “nucleation” refers to the process where the vapor bubble is initiated on the surface above the resistive heater element and from which the functional vapor bubble collapse occurs to eject the ink drop. Ideally, it does not occur until the surface temperature of the resistive heater element gets well above the boiling point of the ink, which occurs during “superheat” of the ink, such that only a single vapor pocket or bubble forms and the ink drop is properly and predictably ejected.)

Thus, there is a continuing need for an innovation that will protect the resistive heater element surface from cavitation damage in order to reduce heater stack failure and thereby enhance heater reliability.

### SUMMARY OF THE INVENTION

The present invention meets this need by providing an innovation which involves only a small degree of change or modification to the heater stack second strata structure and to the currently-employed fabricating processes and which basically is compatible therewith and does not add to the costs. At the same time the modification does not suffer the drawback of the previously-mentioned approach: it does not result in an interface that is exposed to ink in the ejection chamber, thus eliminating the possibility of the occurrence of film delamination. Underlying the innovation of the present invention is the insight by the inventors herein that the most effective approach to finding a solution is to use more of the best material for protection against cavitation, that being, the material used heretofore in the cavitation protective layer itself. However, the solution would not be realized by merely applying a thicker protective layer of the material over the entire resistive heater element. That could adversely impact the energy required to stably jet ink from an individual heater stack in view that the energy required is a function of the area and thickness of its heater stack. Instead, the solution of the invention is to strategically increase the thickness of the layer for cavitation protection in the second strata only at the areas where cavitation generating forces are more likely to occur and impact the second strata or has done so in the past. Thus, only the more likely cavitation affected portions of the second strata which overlie the heater element of the heater will be covered by a thicker layer of Ta, for instance, while other less likely cavitation affected portions of the second strata which overlie the heater element of the heater will remain covered with a layer of Ta of normal thickness to ensure proper jetting energy and jetting performance.

Accordingly, in an aspect of the present invention, a heater stack for a micro-fluid ejection device is structurally enhanced to protect it against adverse effects of cavitation generating forces. The heater stack has first strata and second strata overlying the first strata. The first, or heater forming, strata are configured to support and form a resistive heater element responsive to electrical activation. The second, or protective, strata are configured to protect the heater element from adverse effects of cavitation generating forces occurring on the second strata. The second strata of the heater stack are structurally enhanced by provision of two different thicknesses in various portions of the second strata overlying the heater element. The portions provided with greater thickness overlie areas of the heater element where adverse effects of the cavitation generating forces are more likely to occur and impact the second strata. Thus, the second strata have first portions of a first thickness being at its marginal end portions that overlie the ends of the heater element where adverse effects of cavitation generating forces are more likely to occur on the second strata. A second portion of the second strata that overlies the remaining portion of the heater element extending between its ends has a second thickness less than the first thickness, the remaining portion of the heater element being where adverse effects of cavitation generating forces are less likely to occur on the second strata.

In another aspect of the present invention, a method for making an enhanced heater stack includes processing one sequence of materials to produce first strata supporting and forming a fluid heater element responsive to electrical activation and processing another sequence of materials to produce second strata overlying the first strata and the heater element such that the second strata is provided with different thicknesses in different portions thereof overlying the heater element so as to provide enhanced protection of the heater element from adverse effects of cavitation generating forces occurring in the heater stack on the second strata in accordance with the difference in likelihood of the adverse effects occurring on the different portions of the second strata. The second strata is of greater thickness at those of the different portions thereof where adverse effects of cavitation generating forces are more likely to occur.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view, not to scale, of a prior art heater stack of a micro-fluid ejection device.

FIG. 2 is a cross-sectional view, not to scale, of the prior art heater stack of FIG. 1 shown in conjunction with an ejection chamber and nozzle plate of the micro-fluid ejection device.

FIGS. 3 and 4 are cross-sectional views, not to scale, of an initial sequence of stages in a prior art method of making the heater stack of FIGS. 1 and 2 wherein first (or heater forming) strata of the heater stack are formed.

FIG. 5 is a cross-sectional view, not to scale, of a subsequent stage in the prior art method of making the heater stack of FIGS. 1 and 2 wherein second (or protective) strata of the heater stack are formed on the first strata.

FIG. 6 is a cross-sectional view, not to scale, of an initial stage in two exemplary embodiments disclosed herein of a method of making an enhanced heater stack in accordance with the present invention.

FIG. 7 is a cross-sectional view, not to scale, of a subsequent stage, following the initial stage of FIG. 6, in a first exemplary embodiment of the method of making the enhanced heater stack in accordance with the present invention.

FIGS. 8-10 are cross-sectional views, not to scale, of a subsequent sequence of stages, following the initial stage of FIG. 6, in a second exemplary embodiment of the method of making the enhanced heater stack in accordance with the present invention.

### DETAILED DESCRIPTION

The present invention now will be described more fully hereinafter with reference to the accompanying drawings, in which some, but not all embodiments of the invention are shown and described. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

Also, as indicated earlier, the invention applies to any micro-fluid ejection device, not just to heater stacks for thermal inkjet printheads. While the embodiments of the invention will be described in terms of a thermal inkjet printhead, one of ordinary skill will recognize that the invention can be applied to any micro-fluid ejection system.

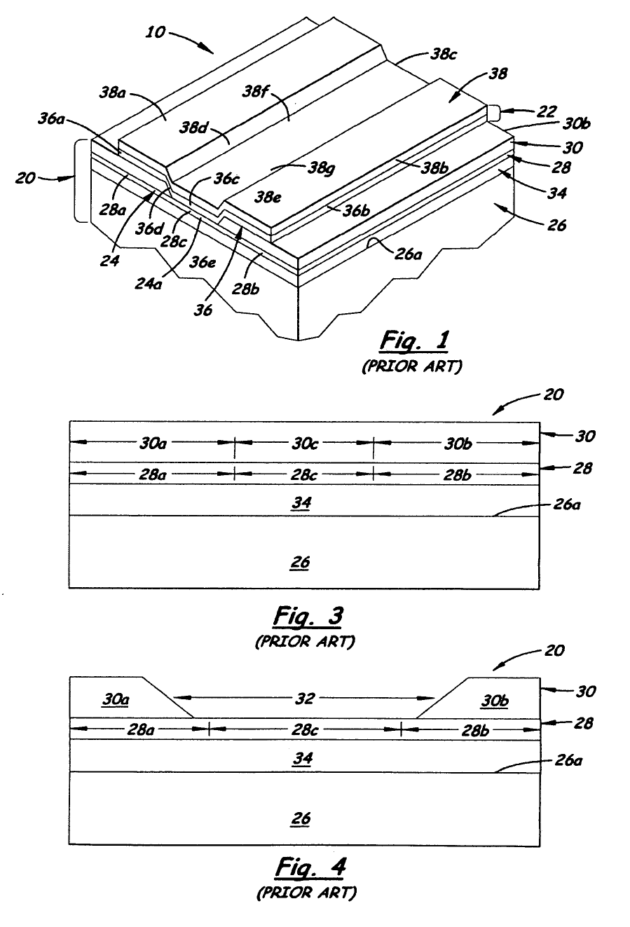

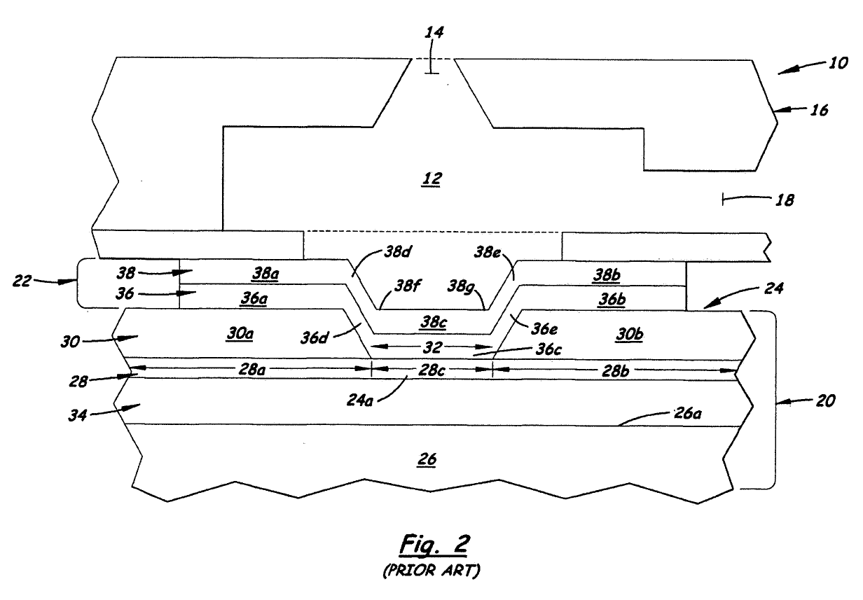

Referring now to FIGS. 1 and 2, there is illustrated a prior art heater stack, generally designated 10, of a micro-fluid ejection device in the form of a thermal inkjet heater chip (and in which the present invention will find application). The heater stack 10 functions in association with an ejection chamber 12 defined in the device. As seen in FIG. 2, the ejection chamber 12 is provided in the device between the heater stack 10 and an orifice or opening 14 in a nozzle plate 16 of the device located above the ejection chamber 12 and continuously supplied with a suitable fluid, such as ink, by a fluid supply channel 18 communicating with the chamber 12 from one side thereof. FIGS. 1 and 2 are similar to ones found in U.S. Pat. Nos. 6,550,893, 6,805,431 and 6,834,941, all assigned to the same assignee as the present invention. The disclosures of these patents are hereby incorporated herein by reference.

The heater stack 10 basically includes first (or heater forming) strata, generally designated 20, and second (or protective) strata, generally designated 22. As will be described hereinafter, the first strata 20 are configured to support and form a heater 24 in the heater stack 10 that is responsive to electrical activation to repetitively cause heating of a fluid, such as ink, in the ejection chamber 12 such that the fluid undergoes a repetitive cycle of vapor bubble expansion and collapse in the ejection chamber 12 to cause jetting of fluid drops from the nozzle opening 14 which, in turn, culminates with the execution of an external process, such as printing on a sheet of paper. The second strata 22 overlie the first strata 20 and are configured to protect a heater element 24a of the heater 24 from any adverse effects occurring on the second strata 22 due to fluid forces generated by the repetitive cycle of bubble expansion and collapse in the fluid in the ejection chamber 12. The ejection device producing such jetted fluid drops has found uses in other non-printing applications, for instance, in the medical, chemical, and mechanical fields. In the printing application, however, in order to print or emit a single drop of ink, the heater element 24a of the heater 24 of the first strata 20 in each heater stack 10 is uniquely addressed by a voltage pulse provided by a printer energy supply circuit (not shown).

More particularly, the first (or heater forming) strata 20 of the heater stack 10 include a substrate 26, such as of silicon, a resistor film or layer 28 overlying the substrate 26, and a conductor film or layer 30 partially overlying the resistor layer 28. The conductor layer 30 has a gap 32 defined therein separating the conductor layer 30 into an anode portion 30a and a cathode portion 30b. The anode and cathode portions 30a, 30b of the conductor layer 30 overlie corresponding spaced apart lateral portions 28a, 28b of the resistor layer 28, with the latter being interconnected by a central portion 28c deposed under and co-extensive with the gap 32 in the conductor layer 30. The anode and cathode portions 30a, 30b of the conductor layer 30, being positive and negative terminals of ground and power leads electrically connected to a tab circuit (not shown), cooperate with the central portion 28c of the resistor layer 28 to form the heater 24 of the first strata 20. The central portion 28c itself defines the resistive heater element 24a of the heater 24 for producing the superheating of the ink in the ejection chamber 12 upon passage of a suitable electrical current through the central portion 28c corresponding to the voltage pulse applied between the anode and cathode portions 30a, 30b of the conductor layer 30. The substrate 26 of the first strata 20 at its front surface 26a usually has a thermal barrier layer 34 thereon underlying the resistor layer 28 and thus the resistive heater element 24a of the heater 24 to prevent heat generated by operation of the heater 24 from being thermally conducted to the substrate 26.

Referring now to FIGS. 3 and 4, there is illustrated an initial sequence of the stages in a prior art method of making the prior art heater stack 10 of FIGS. 1 and 2 and, in particular, the above-described first (or heater forming) strata 20 of the heater stack 10. Turning first to FIG. 3, the substrate 26 in the first strata 20 provides a base layer of silicon upon which all the other layers of the first and second strata 20, 22 are deposited and patterned by conventional thin film integrated circuit processing techniques including layer growth, chemical vapor deposition, photo resist deposition, masking, developing, etching and the like. The thermal barrier layer 34 is grown or deposited on the silicon substrate 26 to provide an insulation or overglaze layer, such as a composite of silicon dioxide mixed with a glass, one being BPSG. With the thermal barrier layer 34 so formed on the front surface 26a of the substrate 26, next, the heater or resistor layer 28, comprised by a first metal typically selected from tantalum/aluminum alloys, tantalum, etc., such as TaAl, is deposited on the substrate 26 over the thermal barrier layer 34. Then, the conductor layer 30, comprised by a second metal typically selected from a wide variety of conductive metals, one being Al, is deposited on the first metal resistive layer 28 to complete the deposition of the layers of the first strata 20, as seen in FIG. 3. Turning next to FIG. 4, once the resistive and conductive layers 28, 30 are deposited, they are patterned, masked and etched, in separate steps by conventional semiconductor processes, such as wet or dry etch techniques. In such manner, the etched first resistor metal layer 28 provides the resistive heater element 24a of the heater 24 and the etched second conductor metal layer 30 provides the power and ground leads for the resistive heating element 24a of the heater 24. By way of example and not of limitation, the various layers of the first strata 20 can have the ranges of thicknesses as set forth in above cited U.S. Pat. No. 6,550,893.

Referring again to FIGS. 1 and 2, the second (or protective) strata 22 of the heater stack 10 overlie the first strata 20 to protect the resistive heater element 24a from adverse effects of fluid forces generated by the repetitive cycle of bubble expansion and collapse in the fluid in the ejection chamber 12. The second strata 22 include a passivation (protective) layer 36 and a cavitation (protective) layer 38. The function of the passivation layer 36 is primarily to protect the resistor and conductor layers 28, 30 of the first strata 20 from ink corrosion. The function of the cavitation layer 38 is to provide protection to the resistive heater element 24a during ink ejection operation which would cause mechanical damage to the heater 24 in the absence of the cavitation layer 38. The cavitation layer 38 is believed to absorb energy from a collapsing ink bubble after ejection of ink drops from the nozzle opening 14.

More particularly, the passivation layer 36 has opposite lateral portions 36a, 36b spaced apart from one another and overlying respectively the anode and cathode portions 30a, 30b of the conductor layer 30 of the first strata 20, and a central portion 36c extending between its lateral portions 36a, 36b but disposed at a level below them. The central portion 36c is disposed between and at substantially the same level as the anode and cathode portions 30a, 30b of the conductor layer 30. At such position, the central portion 36c overlies the central portion 28c of the resistor layer 28 of the first strata 20 that defines the resistive heater element 24a. The passivation layer 36 further includes intermediate wall portions 36d, 36e spaced apart from one another and located at respective opposite lateral ends of the central portion 36c of the passivation layer 36. The intermediate wall portions 36d, 36e extend in oppositely inclined relation to one another and in transverse relation to the lateral portions 36a, 36b and the central portion 36c of the passivation layer 36. Further, the intermediate-wall portions 36d, 36e extend between and interconnect the opposite lateral ends of the central portion 36c respectively with the adjacent ends of the lateral portions 36a, 36b.

The cavitation layer 38 of the second strata 22 has opposite lateral portions 38a, 38b spaced apart from one another and overlying respectively the opposite lateral portions 36a, 36b of the passivation layer 36, and a central portion 38c extending between its lateral portions 38a, 38b but disposed at a level below them. The central portion 38c is disposed between and at substantially the same level as the lateral portions 36a, 36b of the passivation layer 36. At such position, the central portion 38c overlies the central portion 36c of the passivation layer 36 which, in turn, overlies the resistive heater element 24a, the object that the central portion 38c of the cavitation layer 38 is designed to protect. The cavitation layer 38 further includes intermediate wall portions 38d, 38e spaced apart from one another and located at respective opposite lateral ends of the central portion 38c of the cavitation layer 38. The intermediate wall portions 38d, 38e extend in oppositely inclined relation to one another and in transverse relation to the lateral portions 38a, 38b and the central portion 38c of the cavitation layer 38. Further, the intermediate wall portions 38d, 38e extend between and interconnect opposite lateral ends of the central portion 38c respectively with the adjacent ends of the lateral portions 38a, 38b.

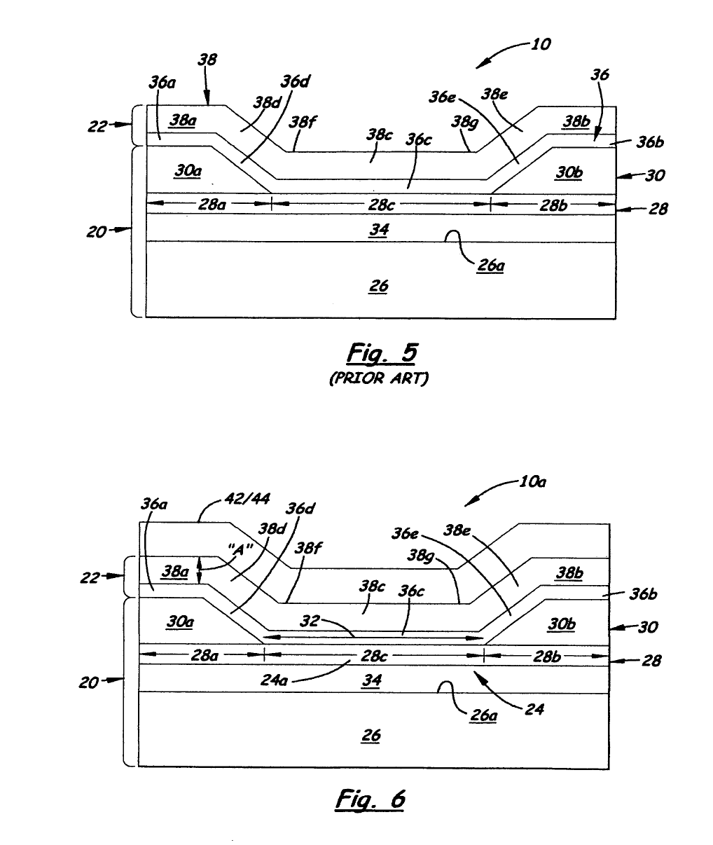

Referring now to FIG. 5, there is illustrated a subsequent stage in the prior art method of making the prior art heater stack 10 of FIGS. 1 and 2 and, in particular, the above-described second (or protective) strata 22 of the heater stack 10. In order to protect the resistor and conductor layers 28, 30 from ink corrosion, the passivation layer 36 of the second strata 22 is deposited over and directly on them. The passivation layer 36 can be a composite layer of silicon nitride and silicon carbide, or one or more individual layers of either or both thereof. Alternatively, the passivation layer 36 can be a suitable dielectric material. The cavitation layer 38 of the second strata 22 is thereafter deposited over the passivation layer 36 such that it also overlies the heater 24 and its resistive heater element 24a. As mentioned earlier, the cavitation layer 38 provides protection to the heater element 24a during ink ejection operation in the chamber 12. Such operation would cause mechanical damage to the heater element 24a in the absence of the cavitation layer 38. The cavitation layer 38 can be a tantalum (Ta) layer. Also, it can be titanium, tungsten, molybdenum and the like. By way of example and not of limitation, the various layers of the second strata 20 can have the ranges of thicknesses as set forth in above cited U.S. Pat. No. 6,550,893.

Turning now to FIGS. 6-10, various stages are illustrated of two exemplary embodiments of a method of making an enhanced heater stack in accordance with the present invention. The enhanced heater stack 10a that results after modification of its second strata 22 by these exemplary embodiments of the method is illustrated both in FIGS. 7 and 10. In the enhanced heater stack 10a, the cavitation layer 38 in the second strata 22 is the one modified to include a structure, in accordance with the present invention, which enhances its protection of the heater element 24a of the heater stack 10a. The modification provides the cavitation layer 38 with different thicknesses in the different portions thereof overlying the passivation layer 20 and thus the heater element 24a underneath it, depending upon the expectation of the degree of damage to occur at these different portions of the cavitation layer 38. Thus, the thickness of the cavitation layer 38 is increased in the portions thereof where adverse effects of cavitation generating forces are more likely to occur. These portions are at the opposite lateral marginal end portions 38f, 38g of its central portion 38c and along the intermediate wall portions 38d, 38e where they merge with one another. In the remainder of the various portions of the cavitation layer 38 where adverse effects of cavitation generating forces are less likely to occur, such as on the surface area throughout the remainder of the central portion 38c between its opposite lateral marginal end portions 38f, 38g, the cavitation layer 38 will remain at its normal thickness, which is less than the aforementioned increased thickness. In view that most of the central portion 38C still has the normal thickness, this serves to minimize the potential side effects of thickness differences on drop jetting energy requirements and thus on drop jetting performance.

The central portion 38c of the cavitation layer 38, retaining its normal thickness as before, also retains it configuration of a substantially planar structure as before, extending between the marginal end portions 38f, 38g thereof which overlies the heater element 24a. Thus, the increased thickness of the cavitation layer 38 at the opposite lateral marginal end portions 38f, 38g of its central portion 38c provides areas of substantially increased thickness over the central portion 38c. These portions of increased thickness now protrude or are elevated above the substantially planar configuration of the central portion 38c so as to have or define the structure 40 having a substantially stepped configuration. These stepped structures 40 will thus overlie each of the opposite ends of the heater element 24a and interconnect the central portion 38c with an increased area of the opposite intermediate wall portions 38d, 38e of the cavitation layer 38 at the regions of transition between the two. By way of example and not of limitation, the increased thickness (“A” in FIG. 7 and “D” in FIG. 10) of the cavitation layer 38 at the stepped structures 40 can be within a range of about 1000 angstroms to about 10,000 angstroms while the normal thickness (“B” in FIG. 7 and “C” in FIG. 10) of the central portion 38c of the cavitation layer 38 is within a range of about 500 angstroms to about 5000 angstroms. In some embodiments, the increased thickness is about two times the normal thickness.

So the exemplary embodiments of the disclosed stages of the method for making the enhanced heater stack 10a, as will be described hereinafter, both involve steps for increasing the thickness of the cavitation layer 38 in these portions thereof in accordance with the present invention. FIG. 6 illustrates an initial stage in both exemplary embodiments, while FIG. 7 illustrates a subsequent stage in the first exemplary embodiment. FIG. 6 also depicts that a cavitation layer 38 having a starting thickness “A”, which is thicker than its normal thickness, is deposited on the passivation layer 36 in the final stage of prior art method shown in FIG. 5. Then, a layer 42 of an inter metal dielectric (IMD) material and/or a passivation overcoat (PO) material is deposited on the cavitation layer 38 of tantalum (Ta), for example. After deposit of IMD/PO layer 42, it is patterned and etched and in addition the cavitation layer 38 underneath it is over etched to a desired final or normal thickness “B” at the central portion 38c thereof extending between its marginal end portions 38f, 38g, which is less than the starting thickness but the same as the normal thickness. This then results in the enhanced heated stack 10a with each of the stepped structures 40 of its cavitation layer 38 at its opposite marginal end portions 38f, 38g of its central portion 38c remaining at the original thickness “A”, as desired, greater than the normal thickness, or thickness “B”, of the central portion 38c of the cavitation layer 38. Thus, in the first exemplary embodiment of the method, to provide a cavitation layer 38 in the second strata 22 having the desired two thicknesses at the desired places, such being greater thickness “A” of the stepped structures 40 at the opposite end portions 38f, 38g and the lesser normal thickness “B” at the central portion 38c, the application of only a single over etch process to the cavitation layer 38 is required.

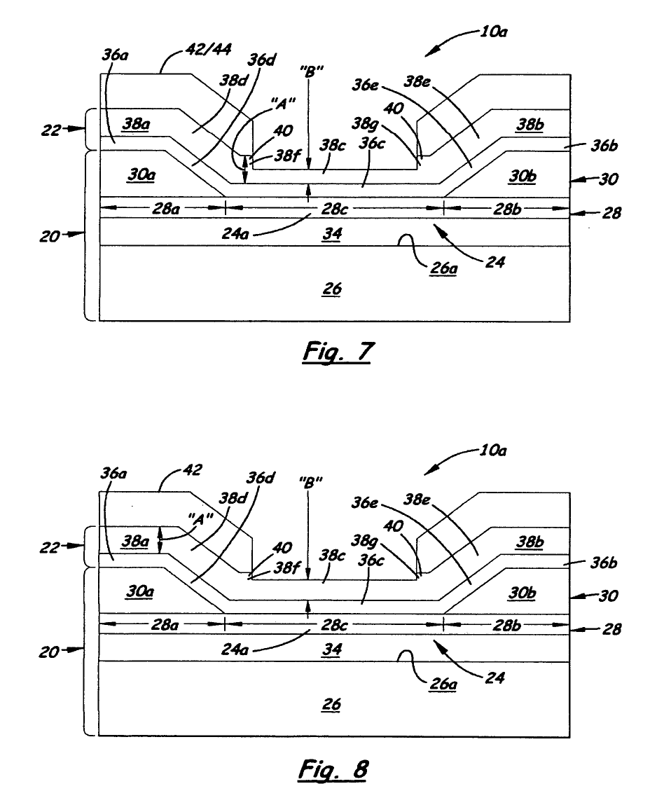

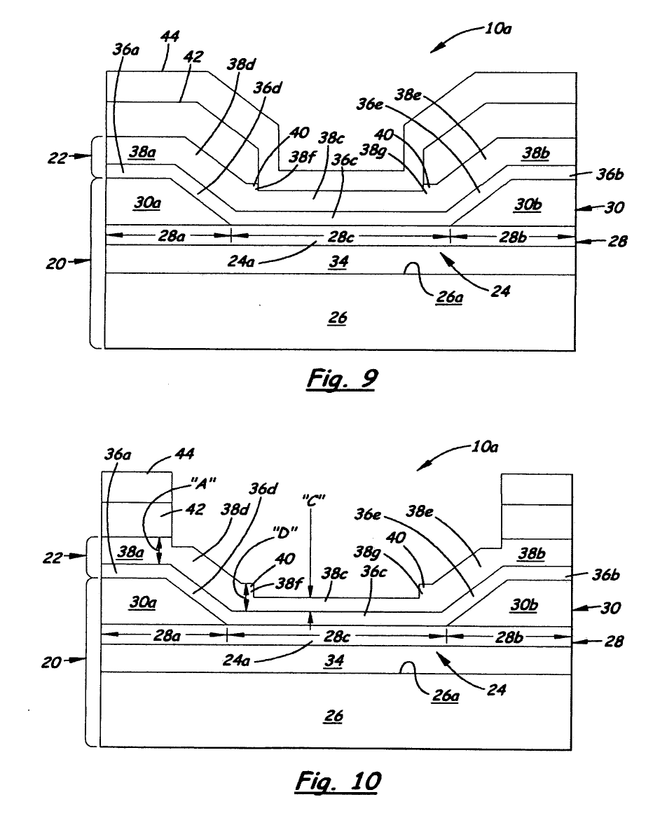

By contrast, the second exemplary embodiment of the method for making the enhanced heater stack 10a shown in FIGS. 8-10 employs a sequence of subsequent stages in which two over etch processes are applied to the cavitation layer 38. FIG. 8 is a stage that is an alternative approach to that of FIG. 7. In FIG. 7, the final normal thickness of the central portion 38f, 38g of the cavitation layer 38, reduced from the starting thickness at each of the stepped structures 40, was achieved, while in FIG. 8 only an intermediate thickness of the central portion 38c of the cavitation layer 38, reduced from the starting thickness at each of the stepped structures 40, was produced. The starting condition in the second exemplary embodiment with regard to the initial stage shown in FIG. 6 is the same as in the first exemplary embodiment above except that now only the layer 42 of IMD material is deposited on the cavitation layer 38. The cavitation layer 38 still has the thickness “A”, which is thicker than its normal thickness. Then, as shown in FIG. 9, a layer 44 of passivation overcoat (PO) material is deposited on IMD layer 42 and on the once over etched cavitation layer 38. After deposit of PO layer 44, the PO layer 44 and IMD layer 42 are etched and in addition the cavitation layer 38 underneath them is over etched again, this time reducing the central portion 38c of the cavitation layer 38 to a desired final thickness “C” at the central portion 38c thereof, which is the same as the normal thickness. This then results in the enhanced heated stack 10a having each of the stepped structures 40 of its cavitation layer 38 at a desired increased thickness “D” greater than the normal thickness “C” but less than the original or starting thickness “A” of the cavitation layer 38.

Other embodiments of the method may be used to provide the increased thickness in the lateral marginal end portions 38f, 38g of the cavitation layer 38. For example, a second Ta deposition and etch could be used, or alternatively a thicker Ta could be deposited in a first step and two masks used to create the stepped structures 40. Another alternative could be two different Ta deposits with an intervening etch to remove the central portion 38c. The desired thickness at each of the stepped structures 40 would be the sum of the thicknesses of the two deposits added together.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A heater stack for a micro-fluid ejection device, comprising:
first strata configured to support and form a fluid heater element responsive to electrical activation; and
second strata overlying said first strata and having different thicknesses in various portions of said second strata overlying said heater element of said first strata so as to provide enhanced protection of said heater element from adverse effects of cavitation generating forces occurring in said device on said second strata in accordance with the difference in likelihood of adverse effects occurring on said various portions of said second strata, said second strata being of greater thickness at those of said various portions thereof where adverse effects of cavitation generating forces are more likely to occur on said second strata.

2. The heater stack of claim 1 wherein a first of said various portions of said second strata where adverse effects of cavitation generating forces are more likely to occur has a first thickness and a second of said various portions of said second strata where adverse effects of cavitation generating forces are less likely to occur has a second thickness less than said first thickness.

3. The heater stack of claim 2 wherein said second of said various portions of said second strata has a substantially planar structure overlying and extending between opposite ends of said heater element of said first strata.

4. The heater stack of claim 3 wherein said first of said various portions of said second strata has a substantially stepped structure overlying each of said opposite ends of said heating element of said first strata and protruding above said substantially planar configuration of said second of said various portions of said second strata.

5. The heater stack of claim 2 wherein:
said first thickness is within a range of about 1000 angstroms to about 10,000 angstroms; and
said second thickness is within a range of about 500 angstroms to about 5000 angstroms.

6. The heater stack of claim 2 wherein said first thickness is about two times said second thickness.

7. The heater stack of claim 1 wherein said first strata include:
a substrate;
a resistor layer overlying said substrate; and
a conductor layer having an anode portion and a cathode portion separated from one another by a gap in said conductor layer and overlying lateral portions of said resistor layer being interconnected and separated by a central portion of said resistor layer deposed under said gap in said conductor layer so as to define said heater element of said first strata.

8. The heater stack of claim 7 wherein said substrate includes a thermal barrier layer underlying said resistor layer.

9. The heater stack of claim 7 wherein said second strata include:
a passivation protective layer having lateral portions spaced apart from one another and overlying respectively said anode and cathode portions of said conductor layer, a central portion extending between said lateral portions of said passivation protective layer and disposed between said anode and cathode portions of said conductor layer and overlying said central portion of said resistor layer defining said heater element, and intermediate wall portions spaced apart from one another and extending in generally transverse relation to, between and interconnecting opposite ends of said central portion of said passivation protective layer respectively with adjacent ends of said lateral portions of said passivation protective layer; and
a cavitation protective layer having lateral portions spaced apart from one another and overlying respectively said lateral portions of said passivation protective layer, a central portion extending between said lateral portions of said cavitation protective layer and disposed between said lateral portions of said passivation protective layer, and intermediate wall portions spaced apart from one another and extending in generally transverse relation to, between and interconnecting opposite marginal end portions of said central portion of said cavitation protective layer respectively with adjacent ends of said lateral portions of said cavitation protective layer;
said cavitation protective layer having said different thicknesses in various portions thereof overlying said passivation protective layer and said heater element of said resistor layer, a first of said various portions where adverse effects of cavitation generating forces are more likely to occur having a first thickness, a second of said various portions being where adverse effects of cavitation generating forces are less likely to occur having a second thickness less than said first thickness and being said central portion of said cavitation protective layer having a substantially planar structure overlying and extending between opposite ends of said heating element, said first of said various portions also having a substantially stepped structure at said opposite marginal end portions of said cavitation protective layer overlying each of said opposite ends of said heater element and protruding above said substantially planar configuration of said central portion of said cavitation protective layer and integrally connected to said central portion and said opposite intermediate wall portions of said cavitation protective layer.

10. A heater stack in a micro-fluid ejection device having an ejection chamber defined in said device between said heater stack and an opening in a nozzle plate of said device, said heater stack comprising:
first strata configured to support and form a heater element responsive to electrical activation to repetitively cause heating of a fluid in said ejection chamber such that the fluid undergoes a repetitive cycle of bubble expansion and collapse in said ejection chamber to cause jetting of fluid drops from said nozzle opening; and
second strata overlying said first strata and configured to provide enhanced protection of said heater element from adverse effects occurring on said second strata of fluid forces generated by said repetitive cycle of bubble expansion and collapse in the fluid in said ejection chamber, said protection of said heater element being enhanced by said second strata having a first portion of a first thickness overlying areas of said heater element where the adverse effects of fluid forces are more likely to occur on said second strata and a second portion of a second thickness overlying other areas of said heater element where the adverse effects of fluid forces are less likely to occur on said second strata, said second thickness being less than said first thickness so as to minimize potential side effects of thickness differences on drop jetting energy requirements and thus on drop jetting performance.

11. The heater stack of claim 10 wherein:
said first thickness is within a range of about 1000 angstroms to about 10,000 angstroms; and
said second thickness is within a range of about 500 angstroms to about 5000 angstroms.

12. The heater stack of claim 11 wherein said first thickness is about two times said second thickness.

13. The heater stack of claim 10 wherein said second of said portions of said second strata has a substantially planar structure overlying and extending between a pair of opposite ends of said heater element of said first strata.

14. The heater stack of claim 13 wherein said first of said portions of said second strata has a substantially stepped structure overlying each of a pair of opposite ends of said heater element of said first strata and protruding above said substantially planar configuration of said second of said portions of said second strata.

15. The heater stack of claim 10 wherein said first strata include:
a substrate;
a resistor layer overlying said substrate; and
a conductor layer having an anode portion and a cathode portion separated from one another by a gap in said conductor layer and overlying lateral portions of said resistor layer being interconnected and separated by a central portion of said resistor layer deposed under said gap in said conductor layer so as to define said heater element of said first strata.

16. The heater stack of claim 15 wherein said substrate includes a thermal barrier layer underlying said resistor layer.

17. The heater stack of claim 15 wherein said second strata include:
a passivation protective layer having lateral portions spaced apart from one another and overlying respectively said anode and cathode portions of said conductor layer, a central portion extending between said lateral portions of said passivation protective layer and disposed between said anode and cathode portions of said conductor layer and overlying said central portion of said resistor layer defining said heater element, and intermediate wall portions spaced apart from one another and extending in generally transverse relation to, between and interconnecting opposite ends of said central portion of said passivation protective layer respectively with adjacent ends of said lateral portions of said passivation protective layer; and
a cavitation protective layer having lateral portions spaced apart from one another and overlying respectively said lateral portions of said passivation protective layer, a central portion extending between said lateral portions of said cavitation protective layer and disposed between said lateral portions of said passivation protective layer, and intermediate wall portions spaced apart from one another and extending in generally transverse relation to, between and interconnecting opposite marginal end portions of said central portion of said cavitation protective layer respectively with adjacent ends of said lateral portions of said cavitation protective layer;
said cavitation protective layer having said different thicknesses in various portions thereof overlying said passivation protective layer and said heater element of said resistor layer, a first of said various portions where adverse effects of cavitation generating forces are more likely to occur having a first thickness, a second of said various portions being where adverse effects of cavitation generating forces are less likely to occur having a second thickness less than said first thickness and being said central portion of said cavitation protective layer having a substantially planar structure overlying and extending between opposite ends of said heater element, said first of said various portions also having substantially stepped structures at said opposite marginal end portions of said cavitation protective layer overlying each of said opposite ends of said heater element and protruding above said substantially planar configuration of said central portion of said cavitation protective layer and integrally connected to said central portion and said opposite intermediate wall portions of said cavitation protective layer.

18. A method for making an enhanced heater stack, comprising:
processing one sequence of materials to produce first strata supporting and forming a fluid heater element responsive to electrical activation; and
processing another sequence of materials to produce second strata overlying said first strata and said heater element such that said second strata are provided with different thicknesses indifferent portions thereof overlying said heater element so as to provide enhanced protection of said heater element from adverse effects of cavitation generating forces occurring in said heater stack on said second strata in accordance with the difference in likelihood of the adverse effects occurring on said different portions of said second strata, said second strata being of greater thickness at those of said different portions thereof where adverse effects of cavitation generating forces are more likely to occur.

19. The method of claim 18 wherein said processing another sequence of materials to produce said second strata includes etching a central portion of a cavitation protective layer of said second strata in order to reduce the central portion by said etching to a final thickness less than an original thickness of said cavitation layer and to leave marginal end portions of the cavitation protective layer located outside of the central portion protruding above the central portion where the marginal end portions are those portions where adverse effects of cavitation generating forces are more likely to occur.

20. The method of claim 18 wherein said processing another sequence of materials to produce said second strata includes etching more than once a central portion of a cavitation protective layer of said second strata in order to reduce the central portion by said etching to a final thickness less than an original thickness of said cavitation layer and to leave marginal end portions of the cavitation protective layer located outside of the central portion with a thickness greater than the final thickness of the central portion where the marginal end portions are those portions where adverse effects of cavitation generating forces are more likely to occur.
